(19) United States
(12) Patent Application Publication
(10) Pub. No.: US 2018/0242613 A1
(43) Pub. Date: Aug. 30, 2018

(54) BALANCED FEED FORMULATION BASED ON TROPICAL LEGUMES AND GRASSES WITH A HIGH PROTEIN CONTENT AND METHOD FOR THE PRODUCTION THEREOF

(71) Applicants: Jose Manuel PIÑA GUTIERREZ, Colonia Florida Villahermosa (MX); Victor Manuel MUNGUIA FLORES, Colonia Florida Villahermosa (MX)

(72) Inventors: Jose Manuel PIÑA GUTIERREZ, Colonia Florida Villahermosa (MX); Victor Manuel MUNGUIA FLORES, Colonia Florida Villahermosa (MX)

(21) Appl. No.: 15/519,143

(22) PCT Filed: Jun. 11, 2015
(86) PCT No.: PCT/IB2015/054402

§ 371 Date: Apr. 13, 2017

(30) Foreign Application Priority Data
Jun. 13, 2014 (MX) MX/A/2014/007113

(51) Int. Cl. A23K 10/33; A23K 20/147; A23K 10/18; A23K 40/00; A23K 50/10

(52) U.S. Cl. CPC A23K 10/33; A23K 20/147; A23Y 2220/00; A23K 40/00; A23K 50/10; A23K 10/18

(57) ABSTRACT

The invention consists of an animal feed formulation based on tropical legumes and grasses with a high protein content, said formulation comprising, inter alia, a combination of grains, a first protein source, forage, a second protein source, a third protein source and a fourth mineral source. One of the protein sources can comprise Canavalia Canavalia ensiformis. The animal feed formulation can also include a forage legume of the Stylosanthes genus. In addition, the animal feed formulation can include a tropical fodder of the Brachiaria or Panicum genera. The synergistic combination of forage legumes and tropical fodder results in a balanced feed with a high concentration of tropical raw materials, which is easy to produce and affordable. Similarly, the invention also comprises a method for producing the feed in pellet form, based on the formulation described above, from which the anti-nutritional factors derived from Canavalia Canavalia ensiformis have been eliminated.

### TECHNICAL FIELD OF THE INVENTION

The present invention relates to the field of animal nutrition, such as ruminants. In particular, this invention is a feed formulation based on tropical legumes and grasses with a high protein content, to improve the weight gain and meat quality, which provides novel advantages over similar solutions of the state of the art.

### BACKGROUND OF THE INVENTION

Currently there is a growing need to feed human beings around the world. In many countries, ruminant animals, mainly cattle and sheep, cover a good demand quantity of human food protein. These types of ruminants are characterized by their ability to feed from forage due to its ability to degrade structural carbohydrates from forage. Therefore, it is a consequent need to find better food for better exploitation of this type of livestock. All living organisms require nutrients, such as carbohydrates, lipids, proteins, vitamins, and minerals for optimum development.

As it is known, tropical zones of the world have a large plant development, including forages such as gramineae or poaceae. However, one of the main problems of forages that grow in the tropics is the low nutritional quality, mainly the protein content. In this regard, one alternative is the use of abundant forage legumes in tropical areas and which protein contents are much higher than gramineae. An additional advantage of legumes is its implementation in crop rotation, and their integration in different production systems due to its association with symbiotic bacteria capable of fixing atmospheric nitrogen for nutrition of other species.

In this regard, there is patent and scientific literature of inventions that propose the use of legumes, seeds, and foliage for livestock feeding. For example, the U.S. Pat. No. 4,357,358 protected an animal feedstuff in pressed form compressed at a pressure less than 700 atmosphere based on agricultural by-products, among which it is optionally mentioned legume foliage. Also, application of U.S. Patent US2011/0281016 describes a prepared feed for a ruminant produced by mixing a plurality of ingredients, wherein at least one is a forage material that enhances digestion of the fodder. Optionally, the material can comprise between cereal foliage, legumes foliage, canola foliage, cereal hay, legume hay, corn stalks, or other suitable stalky materials according to local availability. On the other hand, international patent application WO2012/163364 describes a method and feed composition for reducing the emission of methane and possible other carbonaceous gasses from livestock into the atmosphere. Optionally, the composition can comprise between cereal foliage, legumes foliage, canola foliage, cereal hay, legume hay, corn stalks, or other stalky materials. These three background documents, directed to solve various technical problems, described only the optional use of legume foliage but not legume seed, that is a disadvantage of letting out the valuable nutrients that include legume seed in these compositions for livestock feeding.

In addition, European patent application EP0475684 describes a composition comprising a forage, an effective amount of anti-fungal bacterial, and/or an effective amount of bacterial inoculant to preserve forage, and an effective amount of bacterial humectant. Moreover, European patent application EP2330922 describes a feed for milk-producing animals comprising extruded flax seeds. This application also comprises at least one reducing sugar in the form of a disaccharide comprising at least one fructose unit, derivatives thereof, isomers thereof and mixtures thereof. Finally, U.S. patent application US2013/032336 discloses a high fiber, low density, mono-component (mono-forage) animal feed with high concentrations of long fiber particles derived from forage material. Optionally, such feed can include one or more cereals, vegetables, seeds, nuts, legumes, herbs, vitamins, minerals, fats or combinations of said ingredients. These three cited patent applications, directed to solve various technical problems, do describe the use of legume seeds within a composition or feed for animals feeding. However, these patent applications are not directly addressed to the weight gain or feed improvement for livestock, thus do not make a specific selection of a legume seed.

A legume with better adaptation to the humid tropics is Canavalia Canavalia ensiformis, which has high levels of protein (14% in foliage and 30% in seed), carbohydrates, minerals and vitamins for ruminant animals; particularly ammoniac nitrogen peptides, amino acids, and sulphur, which stimulate the growth of micro-organism population at the level of the rumen. In addition, Canavalia Canavalia ensiformis tolerates different soil types, supports relatively acidity, is undemanding to fertility in soils, is an excellent enhancer of physical, chemical and biological soil because of their ability to fix atmospheric nitrogen, and acts as good reservoirs of carbon dioxide, is a renewable source of energy, protects the soil against erosion, encourages the recycling of nutrients, and its use in topological arrays of 1.00 m×0.50 m reported yields in grain production of up to 3 tons. As an example, Canavalia Canavalia ensiformis has a production of 40 to 50 tons per hectare/year of green material and dry grain yields ranging from 1200 to 3200 kg/hectare. For example, in rotation with corn, it can produce 1428 kg and has a seed yield of 571 to 1428 kg/hectare and can set 200 kg/hectare/year of nitrogen.

In spite of the benefits and advantages mentioned in the preceding paragraph, it is known that the seeds of Canavalia ensiformis include anti-nutritional factors (ANF) as the canavanine and proteins concanavalin A, concanavalin B. The canavanine is similar to essential amino acid arginine and causes the replacement of this protein, which may be the cause of its toxic effect. It is soluble in water so it can be removed by soaking the seeds. The concanavalin A and concanavalin B are a lectin with hematoaglutinante activity, which also interferes with the absorption capacity of nutrients in the intestines, due that destroys the cells of the intestinal mucus.

In this regard, in comparative literature only Mexican patent 266971 of the National Autonomous University of Mexico protects a process to produce precooked flours and/or semolina by means of grains extrusion and agro-industrial harvest for the production of masses and tortillas for human consumption. This invention is not restricted to maize or beans, but can be processed by this invention many other grains such as sorghum, rice, and other legumes such as Canavalia ensiformis, among other grains. While it is true that this patent explicitly mentions Canavalia Canavalia ensiformis, its nutritional implementation is not for animal feed but for human feed; and does not considers the ANF mentioned before within the biological context of ruminants. Finally, the scientific literature on patents is uncertain in relation to the treatment of the above-mentioned ANF derived from Canavalia Canavalia ensiformis.

Moreover, the State of the Art does not mention or suggest the development of a high protein content feed adapted to tropical areas, wherein additionally considers the use of fodder based foliage. One of the main problems with the tropical fodder that grows in tropical regions of the world, is related to their low nutritional quality, especially in the content of protein and digestibility of dry material. An alternative to improve the quality of animal feeding is the use of fodder legumes, such as Canavalia Canavalia ensiformis, as described above, and can be found in great diversity and abundance in tropical areas. Thus, the synergistic combination between forage legumes and tropical fodder enables a resulting balanced feed, with a high supply of tropical raw materials, easy manufacture, and hence affordable.

Therefore, there is a necessity in the State of the Art of a feed formulation for livestock, particularly ruminants, nutritionally enriched by Canavalia Canavalia ensiformis, and wherein the ANF are decreased, which may negatively affect livestock digestion. Moreover, the invention also provides the use of tropical fodder to enrich the development of feed production in order to adapt to the environment of tropical areas. Similarly, this invention provides a method of manufacture of said feed enriched with Canavalia Canavalia ensiformis.

### Objectives of the Invention

An objective of this invention is to provide a feed formulation of livestock, especially ruminants, based on tropical legumes and grasses of high protein content, which allows them to gain weight and improve meat quality.

Another objective of the present invention is that the resultant feed for livestock is adapted to the tropical zone and it is enriched with components that are abundant in these areas.

Another objective of the present invention relates to the proposed feed formulation include Canavalia Canavalia ensiformis, as well as tropical fodder optionally.

Similarly, another objective of the present invention relates to the resultant feed has diminished the anti-nutritional factors.

Finally, another objective of the present invention includes providing the manufacturing process suitable for this product, either fermented, extruded, or pelletized.

### BRIEF DESCRIPTION OF THE DRAWINGS

To provide a better understanding of the invention the following drawing is included herein:

FIG. 1 is a diagram of the feed manufacturing process of the present invention.

### DETAILED DESCRIPTION OF THE INVENTION

The present invention consists of a feed formulation for livestock, particularly ruminants, with tropical legumes and grasses with a high protein content, which incorporates components of abundant growth in tropical areas. Preferably, the feed is intended for ruminants like cattle and sheep. However, it shall be considered within the scope of the present invention, extended use to other animals that can apply the benefits described herein. This feed formulation is balanced and has a high protein content that achieve the nutritional requirements of sheep or cattle. Its main technical effect consists in weight gain and improvement in meat quality.

The essential components of the feed formulation of the present invention are described in the following table:

TABLE 1
Essential components of feed formulation

| Ingredient group | Specific ingredient | Range |
|---|---|---|
| Grain | Maize/Sorghum | 20-30% |
| Protein source | Coconut Paste | 10-15% |
| Forage | Tropical Fodder (Brachiaria | 30-45% |
| | or Panicum) | |
| Protein source | Forage Legume (Canavalia) | 5-25% |
| Protein source | Forage Legume (Stylosantes) | 5-15% |
| Mineral source | Mineral Premix | 0.5-3% |

On the other hand, the non-essential or optional components of the feed formulation of the present invention are included in the following table:

TABLE 2
Optional components of the feed formulation

| Ingredient group | Specific ingredient | Range |
|---|---|---|
| By-product | Bran/Wheat | 10-20% |
| By-product | Molasses | 2-12% |
| Mineral source | Salt | 0.5-3% |
| Mineral source | Calcium Carbonate | 0.1-1% |
| Protein source | Urea | 0.1-3% |
| Fermented Lactobacillus | Vitafer | Variable |

In the feed formulation described in these tables it is proposed to use as a forage legume protein source. In the preferred embodiment of the invention, the forage legume is Canavalia Canavalia ensiformis. In a second embodiment of the invention, the forage legume is a species of the stylosanthes genus. Also, the preferred embodiment of the invention can include a tropical fodder as forage such as a species of the Brachiaria genus. In this way the feed formulation proposed herein contemplates the use of species whose growth and development is adapted to the tropical zones.

In spite of the benefits and advantages mentioned in the preceding paragraphs, it is known that Canavalia Canavalia ensiformis seeds have anti-nutritional factors (ANF), such as the canavanine and protein concanavalin A. The ANF are those compounds that affect the nutritional value some food, especially seeds, because hinder or inhibit the assimilation of nutrients of plant origin foods, generally, including proteins and minerals. From a biochemical point of view, these factors are varied in nature and can be toxic or cause undesirable physiological effects such as flatulence, stomach distension, pancreatic effects, agglutination of red blood cells, decreased the uptake of nutrients, among others. As mentioned above, the substitution of canavanine causes this protein, to be the cause of its toxic effect. The concanavalin A and B is water soluble so it can be removed by soaking the seeds of Canavalia Canavalia ensiformis. Moreover, the concanavalin A is a lectin with hemato-agglutinative activity, that also interferes with the absorption capacity of nutrients in the intestines, which destroys the cells of the intestinal mucus. These ANF have been eliminated through fermentation of Canavalia Canavalia ensiformis. Also, the mentioned ANF of the Canavalia Canavalia ensiformis can be removed by pelletizing by exposing to heat treatment. Preferably, the present invention comprises the pelletizing method of the described feed formulation, which is preferably at least 78 centigrade degrees and at least 56 pressure pounds (2.68 kPa).

Based on the above, the present invention provides an animal feed formulation effective for weight gain and meat quality. The effects of this formulation may be better described and explained based on the following practical experiment.

### Example: The Effect of a Fermented Feed with Canavalia Canavalia ensiformis on Productive Performance in Pelibuey Sheep in Finalization

### General Objective

Studying on productive performance in pelibuey sheep in finalization that are fed with fermented Canavalia Canavalia ensiformis in solid state as a protein source of an integral diet.

### Specific Objectives

### Pelibuey Sheep in Finalization:

1) Determining the influence of fermented Canavalia Canavalia ensiformis in solid state as a protein source of an integral diet on daily weight change.
2) Establishing the effect of fermented Canavalia Canavalia ensiformis in solid state as a protein source of an integral diet on feed efficiency.
3) Determining the quality of carcass in Pelibuey sheep in finalization.

### Hypothesis

The use of grain of Canavalia Canavalia ensiformis in an integral diet that undergoes the process of solid-state fermentation to increase its nutritional value with respect to a integral diet with raw and unfermented in solid state Canavalia Canavalia ensiformis.

For Pelibuey sheep in finalization, the consumption of an integral diet prepared based on the process of solid-state fermentation, wherein the Canavalia Canavalia ensiformis is a major protein source, it can be obtained:

(a) a higher change in weight with respect to registered by means of the consumption of an integral diet prepared based on raw Canavalia Canavalia ensiformis (without been undergone the process of solid state fermentation) as a major protein source.

(b) a change in daily weight similar to that obtained with the consumption of integral diet where the soybean paste is the main protein source.

(c) a higher feed efficiency with respect to the use of integral diets which incorporate raw Canavalia Canavalia ensiformis or soybean paste.

(d) improved carcass quality in pelibuey sheep in finalization an integral diet prepared based on Canavalia Canavalia ensiformis.

### Formulas Used in Animal Feed

Formulation 1
Formulations with Canavalia ensiformis

| Ingredient | % |
|---|---|
| Maize | 32.70 |
| Canavalia ensiformis | 25.00 |
| Stylosantes guinensis | 5.00 |
| Hay grass MG5 | 12.70 |
| Molasses | 19.30 |
| Mineral premix | 2.00 |
| Oil | 3.00 |
| Urea | 0.30 |

This formulation presents a guaranteed analysis of:

| | |
|---|---|
| Raw Protein | 14% |
| Raw Fiber | 17% |
| Ashes | 5% |
| Humidity | 12% |
| Raw lipids | 5% |
| N.F.E. | 47% |

Formulation 2
Formulations with fermented Canavalia ensiformis

| Ingredient | % |
|---|---|
| Maize | 32.70 |
| Canavalia ensiformis | 25.00 |
| Stylosantes guinensis | 5.00 |
| Hay grass MG5 | 12.70 |
| Molasses | 19.30 |
| Mineral premix | 2.00 |
| Oil | 3.00 |
| Urea | 0.30 |

This formulation presents a guaranteed analysis of:

| | |
|---|---|
| Raw Protein | 14% |
| Raw Fiber | 17% |
| Ashes | 5% |
| Humidity | 12% |
| Raw lipids | 5% |
| N.F.E. | 47% |

Formulation 3
Formulations with soybean paste

| Ingredient | % |
|---|---|
| Maize | 40.70 |
| Stylosantes guinensis | 15.00 |
| Hay grass MG5 | 4.00 |
| Soybean paste | 20.00 |
| Molasses | 15.00 |
| Mineral premix | 2.00 |
| Oil | 3.00 |
| Urea | 0.30 |

This formulation presents a guaranteed analysis of:

| | |
|---|---|
| Raw Protein | 17% |
| Raw Fiber | 17% |
| Ashes | 5% |
| Humidity | 12% |
| Raw lipids | 5% |
| N.F.E. | 44% |

### Results

Least squares means (±standard errors) of the initial and final weights, and daily change of weight in pelibuey sheep feed with integral diets prepared based on seeds of Canavalia ensiformis.

| | Diet Type | | |
|---|---|---|---|
| | Formulation | Formulation | |
| | 1 with non | 2 with | Formulation |
| | fermented | fermented | 3 without |
| | Canavalia | Canavalia | Canavalia |
| Variable | ensiformis | ensiformis | ensiformis |
| Initial weight | 21.0 ± 1.1 | 20.8 ± 1.1 | 22.2 ± 1.2 |
| (kg) | | | |
| Final weight | 25.2 ± 1.7 ^{a} | 28.0 ± 1.7 ^{a} | 35.5 ± 1.8 ^{b} |
| (kg) | | | |
| Change of | 62.0 ± 13.4 ^{a} | 107.0 ± 13.4 ^{b} | 195.0 ± 14.6 ^{c} |
| daily weight | | | |
| (g) | | | |
| Spleen (g) | 55.3 ± 9.7 | 54.5 ± 6.9 | 80.8 ± 9.7 |
| Assesment | 68 | 68 | 68 |
| duration | | | |
| (days) | | | |

Where a, b, c values with different superscript within the same row indicate significant difference (p<0.01).

Influence of the diet type in finalization in body composition of pelibuey sheep.

| | Diet Type | | |
|---|---|---|---|
| | Formulation | Formulation | |
| | 1 with non | 2 with | Formulation |
| | fermented | fermented | 3 without |
| | Canavalia | Canavalia | Canavalia |
| Variable | ensiformis | ensiformis | ensiformis |
| Living weight at | 25.2 ± 1.7 ^{a} | 28.0 ± 1.7 ^{a} | 35.5 ± 1.8 ^{b} |
| slaughtering (kg) | | | |
| Hot carcass weight | 11.3 ± 0.8 ^{a} | 12.4 ± 0.8 ^{a} | 16.8 ± 0.9 ^{b} |
| (kg) | | | |
| Cold carcass weight | 11.1 ± 0.8 ^{a} | 12.2 ± 0.8 ^{a} | 16.6 ± 0.9 ^{b} |
| (kg) | | | |
| Hot carcass | 44.7 ± 1.\|1 | 44.2 ± 1.1 | 47.5 ± 1.2 |
| performance (%) | | | |
| Chest circumference | 63.2 ± 1.3 | 63.2 ± 1.3 | 67.4 ± 1.4 |
| (cm) | | | |
| Carcass lenght (cm) | 49.6 ± 1.5 ^{a} | 52.7 ± 1.5 ^{a} | 59.2 ± 1.7 ^{b} |
| Leg lenght (cm) | 40.7 ± 0.7 | 40.5 ± 0.7 | 41.8 ± 0.8 |
| Major diameter of L. | 4.8 ± 0.2 ^{c} | 5.2 ± 0.2 ^{d} | 5.8 ± 0.2 ^{d} |
| dorsi muscle (cm²) | | | |
| Minor diameter of L. | 2.2 ± 0.1 | 2.3 ± 0.1 | 2.7 ± 0.2 |
| dorsi muscle (cm²) | | | |
| Fat cover (mm) | 0. 9 ± 0.4 ^{a} | 0.7 ± 0.4 ^{a} | 2.8 ± 0.4 ^{b} |
| Neck (kg) | 1.1 ± 0.1 ^{a} | 1.0 ± 0.1 ^{a} | 1.6 ± 0.1 ^{b} |
| Chest (kg) | 3.0 ± 0.3 ^{a} | 3.4 ± 0.3 ^{a} | 4.8 ± 0.3 ^{b} |
| Arm-shoulder (kg) | 1. 9 ± 0.1 ^{a} | 2.2 ± 0.1 ^{a} | 2.7 ± 0.2 ^{b} |
| Abdomen (kg) | 2.3 ± 0.3 ^{a} | 2.8 ± 0.3 ^{a} | 3.8 ± 0.3 ^{b} |
| Leg (kg) | 2.6 ± 0.2 ^{a} | 2.6 ± 0.2 ^{a} | 3.5 ± 0.2 ^{b} |

Wherein: The least-squares mean (±standard error)
^{a, b} values with different superscripts in the same row indicate significant difference (p < 0.01);
^{c, d} values with different superscripts in the same row indicate significant difference (p < 0.05).

### Conclusions

The use of forage legumes such as Canavalia Canavalia ensiformis in an integral diet that undergoes the process of solid-state fermentation to increase its nutritional value with respect to an integral diet with unfermented in solid state and raw Canavalia ensiformis.

The use of forage legumes such as Canavalia Canavalia ensiformis in an integral diet obtains a higher change of weight with respect to registered with the consumption of an integral diet prepared based on raw Canavalia Canavalia ensiformis, and without been undergone to the process of solid state fermentation, as a major protein source.

The use of forage legumes such as Canavalia Canavalia ensiformis in an integral diet obtains change of daily weight similar to that obtained with the consumption of an integral diet where the soybean paste is the main protein source.

The use of forage legumes such as Canavalia Canavalia ensiformis in an integral diet obtains a greater feed efficiency with respect to the use of integral diets, which incorporates raw Canavalia ensiformis or soybean paste.

Better carcass quality in pelibuey sheep in finalization of an integral diet prepared based on forage legumes such as Canavalia Canavalia ensiformis.

The use of forage legumes such as Canavalia Canavalia ensiformis in an integral diet obtains sheep with better carcass quality in sheep carcass classification based on the fat/shaping relationship of light lambs according to the official standard MX-FF-CFIDS-2006 Mexico Extra (MEX EXT) are those carcasses from light lambs with surface fat of 1 mm to 3 mm and excellent conformation.

Based on the example described above, we found that a diet including Canavalia Canavalia ensiformis complies with the effect of weight gain and improvement in meat quality. However, this example also shows that the Canavalia Canavalia ensiformis which has not been treated (e.g. fermentation, for the experimental case described), then it may cause a negative non-desired effect.

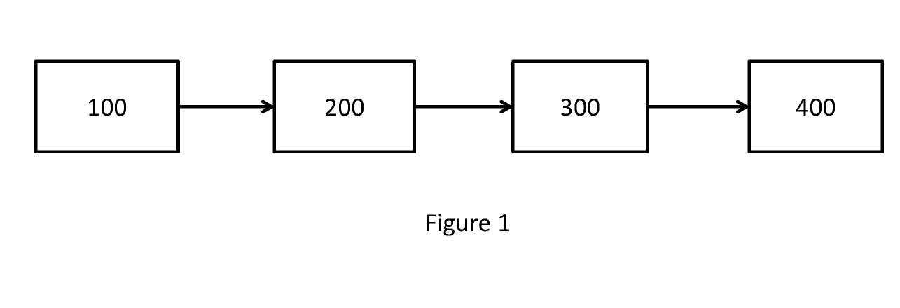

Finally, FIG. 1 describes the method to carry out the manufacture of the feed formulation of the proposed invention. Accordingly, a first step consists in a milling process (100) of forages and legumes. The second step consists in a dosing (200) so that each specific ingredient or component percentage falls within the range specified in Table 1. The third step involves a mixing process (300) of all the selected components according to the feed formulation. It should be noted that the Canavalia Canavalia ensiformis must be present in the indicated percentages. Preferably, the milling process (100), dosing (200), and mixing (300) may be performed by methods known in the State of the Art. Finally, the fourth step consists in a pelletizing process (400) wherein the extrusion temperature reaches at least 78° C. and at least 2.67 kPa of pressure. Similarly, the pelletizing process (400) can be carried out by machines known in the State of the Art. In alternative embodiments of the invention, the feed can also be fermented or extruded.

Based on the previous disclosure, certain embodiments and details have been described in order to illustrate the present invention, and it will be evident to the experts that can make variations and modifications without departing from the scope of the present invention.

1. An animal feed formulation based on tropical legumes and grasses with a high protein content, comprising: 20% to 30% of a combination of grains, 10 to 15% of a first protein source, 30% to 45% of a forage, 5% to 25% of a second protein source, 5% to 15% of a third protein source, and 0.5% to 3% of a first mineral source; wherein the second protein source comprises Canavalia Canavalia ensiformis.

2. The animal feed formulation according to claim 1, wherein the combination of grains includes maize or sorghum.

3. The animal feed formulation according to claim 1, wherein the first protein source includes coconut paste.

4. The animal feed formulation according to claim 1, wherein the third protein source includes a forage legume of Stylosanthes genus.

5. The animal feed formulation according to claim 1, wherein the forage comprising a tropical fodder of Brachiaria genus.

6. The animal feed formulation according to claim 1, wherein the first mineral source comprises a mineral premix.

7. The animal feed formulation according to claim 1, wherein the feed formulation also includes 10% to 20% of a first by-product.

8. The animal feed formulation according to claim 7, wherein the first by-product includes bran, wheat, or both.

9. The animal feed formulation according to claim 1, wherein the feed formulation also includes 2% to 12% of a second by-product.

10. The animal feed formulation according to claim 9, wherein the second by-product comprises molasses.

11. The animal feed formulation according to claim 1, wherein the feed formulation also includes from 0.5% to 3% of a second mineral source.

12. The animal feed formulation according to claim 11, wherein the second mineral source comprise salt.

13. The animal feed formulation according to claim 1, wherein the feed formulation also includes from 0.1% to 1% of a fourth protein source.

14. The animal feed formulation according to claim 13, wherein the fourth protein source comprises urea.

15. The animal feed formulation according to claim 1, wherein the feed formulation also includes a variable percentage of lactobasillus.

16. The animal feed formulation according to claim 1, wherein the Canavalia Canavalia ensiformis can be fermented, pelletized or extruded.

17. The animal feed formulation according to claim 16, wherein the Canavalia ensiformis is pelleted at least at 78° C. and at least 2.67 kPa of pressure.

18. A manufacturing process using an animal feed formulation adapted to tropical areas, comprising: 20% to 30% of a combination of grains, 10 to 15% of a first protein source, 30% to 45% of forage, 5% to 25% of a second protein source which is Canavalia Canavalia ensiformis, 5% to 15% of a third protein source, and 0.5% to 3% of a first mineral source characterized in that it comprises: a grinding process; dosing; mixing process; and a pelletizing process wherein extrusion temperature reach at least 78° C. and at least 2.67 kPa of pressure.

19. The manufacturing process according to claim 18, wherein the grinding processes, dosing, mixing and pelletizing can be carry out by methods and machines known in the State of the Art.

20. An animal feed derived from manufacturing process in accordance with claim 18.
